(19) United States
(12) Patent Application Publication
(10) Pub. No.: US 2024/0271964 A1
(43) Pub. Date: Aug. 15, 2024

(54) Linear Position Transducer

(71) Applicant: Regal Components AB, Uppsala (SE)

(72) Inventors: Linus FALK, Uppsala (SE); Henrik NORDÉN, Alunda (SE); Erik LEJMAN, Uppsala (SE); Sofia LÖFSTRAND, Falun (SE)

(21) Appl. No.: 18/570,324

(22) PCT Filed: Apr. 28, 2022
(86) PCT No.: PCT/SE2022/050407

§ 371 Date: Dec. 14, 2023

(30) Foreign Application Priority Data
Jun. 18, 2021 (SE) 2150788-4

(51) Int. Cl. G01D 5/14; G01B 7/30

(52) U.S. Cl. CPC G01D 5/145; G01B 7/30

(57) ABSTRACT

A linear position transducer (10) comprises a sensor rod (30), a plurality of Hall effect sensor elements (34), an axial ring magnet (40) and an embedded microcontroller system (24). The axial ring magnet is arranged around the sensor rod. The Hall effect sensor elements are arranged within an interior (31) of the sensor rod. The Hall effect sensor elements are arranged with an off-axis displacement with respect to an axis of the sensor rod and are configured to provide signals representing at least two components, transverse to each other, of a magnetic field at the respective position. The embedded microcontroller system is communicationally connected to the Hall effect sensor elements and is configured for determining a relative axial position between the axial ring magnet and the sensor rod on received signals representing the two components of the magnetic field from each of at least two Hall effect sensor elements.

### TECHNICAL FIELD

The present technology relates in general to position transducers and methods for determining positions, and in particular to linear position transducers and methods for determining positions along a linear path.

### BACKGROUND

When a relative position between two parts that are movable with respect to each other is to be determined, one often used approach is to attach some kind of sensor or sensor system at one of the parts that is perceptible for sensing characteristic features of the other part. These characteristic features may be natural features of this other part, or can be features added for the purpose of position detection.

One possibility is to include a magnetic field source at one part and a magnetic field sensor at the other part. The strength of the magnetic field measured by the sensor then gives some information about the position relative to the magnetic field source. Since the physical positions of the magnetic field source and the magnetic field sensor relative the respective part, a relative position between the parts is possible to estimate.

In a linear position transducer using magnetic sensing, for use e.g. in a piston and cylinder arrangement, a magnetic-field source can be attached to one of the parts and a set of magnetic-field sensors, e.g. Hall effect sensor elements, can be attached to the other part along a linear path. When a magnetic-field sensor comes close to the magnetic-field source, a magnetic field is detectable and an output signal representing the detected field can be obtained from the magnetic-field sensor. By arranging the magnetic-field sensors close enough, one may assure that at least one magnetic-field sensor is situated within detecting distance from the magnetic-field source. In such a way, a relative position of the two parts along the linear path can be determined or at least estimated.

However, there are some general difficulties with such arrangements. Since magnetic fields may influence many parts of a system, the strength of used magnetic fields for positioning purposes has generally to be kept relatively weak. The distance at which e.g. a Hall effect sensor element can detect the magnetic strength thereby becomes limited. A typical distance from a magnetic source within which a Hall effect sensor element detects a reasonable magnetic field signal can be in the order of ±5 mm. In order to cover all positions along the path, Hall effect sensor elements thereby have to be distanced from each other by not more than typically 10-15 mm. If a total stroke of a cylinder/piston arrangement is e.g. 0.5 m, a large number of Hall effect sensor elements are needed. Such a large number of Hall effect sensor elements in turn require an extensive collection and processing of data.

### SUMMARY

A general object of the present technology is to provide user friendly linear position transducers.

The above object is achieved by methods and devices according to the independent claims. Preferred embodiments are defined in dependent claims.

In general words, in a first aspect, a linear position transducer comprises a sensor rod, a plurality of Hall effect sensor elements, an axial ring magnet and an embedded microcontroller system. The axial ring magnet has a hole with a diameter larger than a diameter of the sensor rod. The axial ring magnet is arranged around the sensor rod. The plurality of Hall effect sensor elements is arranged within an interior of the sensor rod. The Hall effect sensor elements are configured to provide signals representing a magnetic field at the position of the respective Hall effect sensor element. The Hall effect sensor elements are arranged with an off-axis displacement with respect to an axis of the sensor rod. The Hall effect sensor elements are configured to provide signals representing at least two components, transverse to each other, of a magnetic field at the position of respective the Hall effect sensor element. The embedded microcontroller system is communicationally connected to the plurality of Hall effect sensor elements for receiving signals representing magnetic fields. The microcontroller system is configured for determining a relative axial position between the axial ring magnet and the sensor rod, in all situations, based on the received signals representing magnetic fields and in particular based on received signals representing the at least two components of the magnetic field from each of at least two of the Hall effect sensor elements.

In a second aspect, a cylinder of piston type comprises a piston, a cylinder body and a linear position transducer according to the first aspect.

In a third aspect, a method for determining a linear position comprises registering of parameters of a magnetic field by a plurality of Hall effect sensor elements arranged within an interior of a sensor rod, wherein the sensor rod is located through an axial ring magnet. The Hall effect sensor elements are arranged with an off-axis displacement with respect to an axis of the sensor rod. Thereby, the registering of parameters of a magnetic field comprises registering parameters of at least two transverse components of the magnetic field. Signals representing the magnetic field are communicated to an embedded microcontroller system, and in particular signals representing the parameters of at least two transverse components of the magnetic field from at least two Hall effect sensor elements are communicated. A relative axial position between the axial ring magnet and the sensor rod is determined, in all situations, based on the communicated signals representing the magnetic fields, and in particular based on communicated signals representing the at least two transverse components of the magnetic field from each of the at least two of the Hall effect sensor elements.

One advantage with the proposed technology is that the needed density of Hall effect sensors is decreased. Other advantages will be appreciated when reading the detailed description.

### BRIEF DESCRIPTION OF THE DRAWINGS

The invention, together with further objects and advantages thereof, may best be understood by making reference to the following description taken together with the accompanying drawings, in which:

FIG. 1 is a schematic illustration of a cylinder of piston type comprising an embodiment of a linear position transducer;

FIG. 2 is a cross-sectional view of an embodiment of a linear position transducer;

FIG. 3 is another cross-sectional view of an embodiment of a linear position transducer;

FIG. 4 is a diagram of an example of measured magnetic field strength from Hall effect sensor elements arranged at an axis of an axial ring magnet;

FIG. 5 is a diagram of an example of measured magnetic field strength in different directions from Hall effect sensor elements arranged off-axis with respect to an axial ring magnet;

FIG. 6 is a flow diagram of steps of an embodiment of a method for determining a linear position;

FIG. 7 is a flow diagram of part steps of embodiments of a communication step of a method for determining a linear position;

FIG. 8 is a schematic illustration of parts of an embodiment of a linear position transducer configured for a master-slave approach; and

FIG. 9 is a schematic illustration of an embodiment of a transducer function diagram.

### DETAILED DESCRIPTION

Throughout the drawings, the same reference numbers are used for similar or corresponding elements.

Throughout the description, the terms “sensor” and “transducer” is used in the field of positioning. Since such terms may have slightly different use in different fields of technology, a definition of how the terms are used within this disclosure is presented here.

The words ‘Position sensor’ and ‘position transducer’ are often used as synonyms in some applications. A sensor measures a physical quantity, e.g. temperature, light, magnetic field etc., and convert it to a readable output. Hence, a position sensor measures a physical quantity and convert it to some kind of a signal representing a position. However, the original output from the sensor is not always useful and require typically some signal conditioning. A transducer converts one energy form to another and in this context the transducer operates the signal conditioning. Signal conditioning adds filters, error monitoring, electromagnetic protection, reverse polarity protection, and convert the sensor output to a useful format etc.

A device that contains both sensors, signal conditioning and mechanical housing may sometimes in prior art be called ‘position sensor’, but in the present disclosure the term ‘position transducer’ is instead used. Therefore, in this description ‘sensor’ refers to the sensor elements in the device. The sensor elements are typically integrated circuits, typically mounted on a printed circuit board (PCB). Examples of such sensors are for example Hall effect sensors. The complete device with sensors, signal conditioning and mechanical housing will in this disclosure be referred to as ‘position transducer’ to differentiate the complete device from the bare sensor elements.

For a better understanding of the proposed technology, linear position transducer intended for use in an arrangement of a cylinder of piston type is used as a model example in the detailed description below. However, any person skilled in the art realizes that the same linear position transducer concept is applicable to many different kinds of technical systems, where a relative linear displacement between two parts is involved.

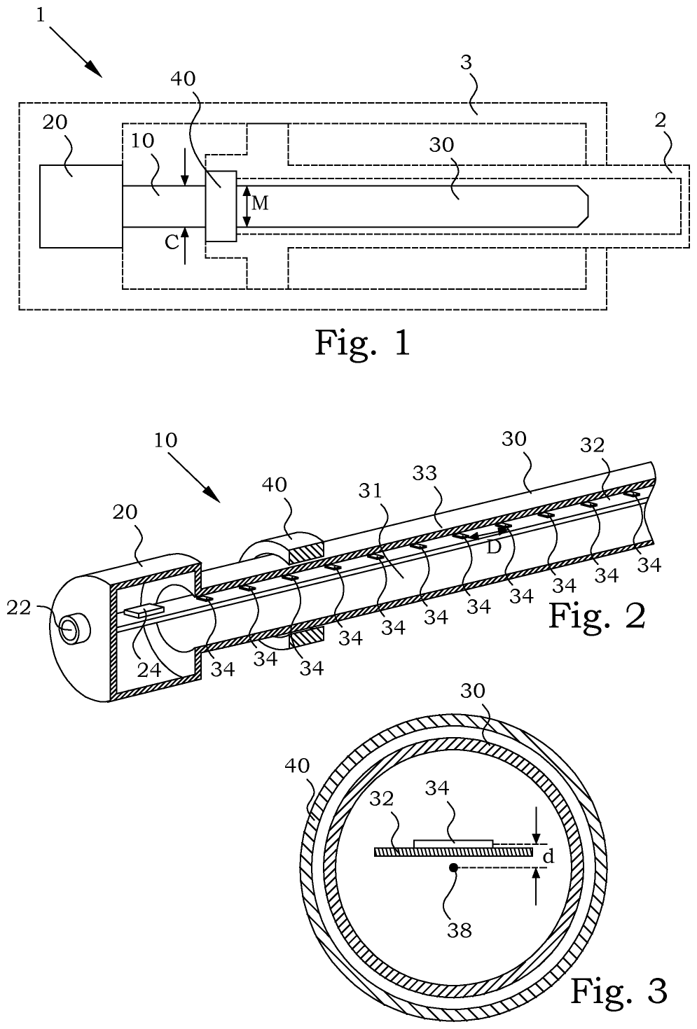

FIG. 1 illustrates schematically an embodiment of a linear position transducer 10. The linear position transducer 10 is here indicated as being used in a cylinder 1 of piston type, illustrated with dotted lines. A cylinder of piston type here denotes a cylinder having a cylinder body, in which a movable piston is provided. Typical examples of cylinders of piston type are a hydraulic cylinder or a pneumatic cylinder. The linear position transducer 10 comprises a header 20, a sensor rod 30 and an axial ring magnet 40. In this particular application, the header 20 can be mounted in the cylinder body 3 and the sensor rod 30 extends into the piston 2 of the cylinder 1 of piston-type, whereas the axial magnet 40 is mounted in the piston 2. The axial ring magnet 40 has a hole with a diameter M that is larger than a diameter C of the sensor rod 20. The axial ring magnet 40 is arranged around the sensor rod 30.

FIG. 2 illustrates the linear position transducer 10 with a part of the rod shell 33, a metal tube for protection, broken away, revealing the interior 31 of the sensor rod 30. A plurality of Hall effect sensor elements 34 are arranged within the interior 31 of the sensor rod 30, along the axis, along which a relative motion is intended. The Hall effect sensor elements 34 are configured to provide signals representing a magnetic field at the position of the respective Hall effect sensor element 34. The Hall effect sensor elements 34 are provided with a mutual distance D, which will be further discussed below. In this particular embodiment, the Hall effect sensor elements 34 are provided on a printed circuit board (PCB) 32. The PCB 32 extends throughout essentially the entire interior 31 of the sensor rod 30 and into the header 20. An embedded microcontroller system 24 is provided at the PCB 32, at a position allowed by e.g. available space. The embedded microcontroller system 24 is communicationally connected to the plurality of Hall effect sensor elements 34. Thereby, signals representing magnetic fields can be received by the embedded microcontroller system 24. The microcontroller system is configured for determining a relative axial position between the axial ring magnet 40 and the sensor rod 30 based on the received signals representing magnetic fields, The PCB 32 typically also provides a power supply circuit, Electromagnetic Compatibility (EMC) components, a digital to analogue converter and other signal conditioning components.

The use of an axial ring magnet 40 has certain advantages. An axial ring magnet 40 is geometrically symmetrical and creates a magnetic field that in an ideal case is symmetric around the axis of the axial ring magnet 40. The magnetic field thus varies in radial direction in the same manner independent on in which particular direction is concerned. This means that the sensor rod 30 can be mounted relative to the axial ring magnet 40 in different rotational directions without affecting the magnetic field experienced by the Hall effect sensor elements 34. At the same time, the axial ring magnet 40 provides a magnetic field changing its strength along the axis, and is therefore suitable for positioning purposes.

FIG. 3 illustrates an embodiment of a linear position transducer 10 in a cross-sectional view seen along an axis 38 of the sensor rod 30. The interior 31 of the sensor rod 30 may be open, as illustrated, or at least partially filled, for further protection of the components of the PCB 32. The PCB 32 is, however, mechanically fixed relative the sensor rod 30. The filling material may e.g. be different types of resins. Here, it can be noticed that the Hall effect sensor elements 34 are arranged with an off-axis displacement d with respect to the axis 38 of the sensor rod 30.

The off-axis placement of the Hall effect sensor elements 34 has particular advantages. Along the axis of an axial ring magnet 40, the magnetic field is directed parallel to the axis. In other words, a Hall effect sensor element 34 located on the axis can only detect one component of the magnetic field along the axis and a component of the magnetic field transverse to the axis will not be detected, hence only one signal will be useful. By instead placing the Hall effect sensor elements 34 in an off-axis position, the detected magnetic field will present components in the direction of the axis as well as in a direction transverse thereto. The off-axis placement thereby provides two independent measures of the magnetic field.

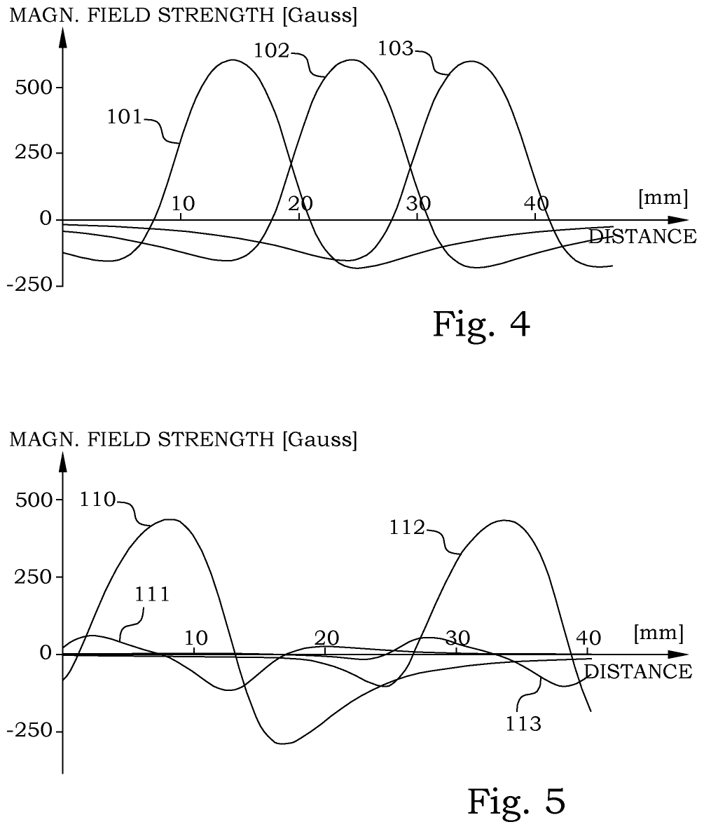

FIG. 4 presents a diagram illustrating measured magnetic field strengths 101, 102, 103 along an axis of an axial ring magnet as measured by three Hall effect sensor elements positioned 10 mm apart from each other. Each Hall effect sensor element presents a maximum detected field when the Hall effect sensor element is placed exactly in the center of the axial ring magnet. If a position is to be determined by such a set-up, measured magnetic field strengths are correlated with predefined relation data between magnetic field strengths and relative axial positions. However, from this, it is understood that the Hall effect sensor element have to be positioned relatively close to each other, in order to give a combined knowledge enough for deducing an estimate of the position. If the three Hall effect sensor elements are positioned further apart from each other, full conclusiveness of the position from the obtained measurements may be difficult. When only one dimension of the magnetic field is used, the data from the Hall effect sensor elements must cross each other in order to assure that the unique position estimation is not lost. This means that a short distance between the Hall effect sensor elements is necessary.

FIG. 5 presents a similar diagram illustrating measured magnetic field strengths of an axial ring magnet as measured by two Hall effect sensor elements positioned 25.6 mm apart from each other and in an off-axis position relative to the axial ring magnet axis. Two components for each Hall effect sensor element is presented. Curve 110 represents an axial component of the magnetic field for a first Hall effect sensor element and curve 111 represents a component of the magnetic field transverse to the axis of the axial ring magnet for this first Hall effect sensor element. Analogously, curve 112 represents an axial component for a second Hall effect sensor element and curve 113 represents a transverse component for the second Hall effect sensor element. Since also the transverse components 111 and 113 provides some non-zero signals relatively far out from the centre of the respective axial components, the combined information of both the axial components and the transverse components may allow the Hall effect sensors to be separated far more than in a centred configuration. The distance, denoted D in FIG. 2, i.e. the spacing between two consecutive Hall effect sensor elements can thus be more than doubled. This in turn reduces the number of requested Hall effect sensor elements by the same factor.

In other words, in one embodiment, the Hall effect sensor elements are spaced apart along the axis of the sensor rod by more than 20 mm, preferably by more than 25 mm.

In the example of FIGS. 4 and 5, one component has been selected to be along the axis of the axial ring magnet. In alternative embodiments, both measured components may be non-parallel to the axis. The resulting curves will differ in shapes, but the main principles of using two transverse components of a single Hall effect sensor element will still be applicable.

It will of course also be possible to measure more than two components. Many Hall effect sensor elements measure three perpendicular components. One may then in one embodiment use two of them for the above ideas. Alternatively, in other embodiments, all three components can be used.

Thus, in one embodiment with the Hall effect sensor elements arranged with an off-axis displacement with respect to the axis of the sensor rod, the Hall effect sensor elements may be configured to provide signals representing at least two components, transverse to each other, of a magnetic field at the position of respective the Hall effect sensor element. The microcontroller system is then consequently configured for determining the relative axial position based on received signals representing the at least two components of the magnetic field from at least two of the Hall effect sensor elements.

In a further embodiment, the microcontroller system is configured for determining the relative axial position by correlating magnetic field strengths of the at least two components of the at least two Hall effect sensor elements with a relative axial position between the axial ring magnet and the sensor rod. The correlation is performed according to predefined relation data between magnetic field strengths and relative axial positions.

The two transverse components of the magnetic field can in principle be any combination of transverse components. However, since the axial ring magnet ideally provides a magnetic field having its main direction directed along the axis, components in the axial direction or close thereto are typically the strongest. Strong signals enable position estimations with an increased distance between the Hall effect sensor elements and it is therefore preferred to have one of the components in a direction close to the axis. The other transverse, preferably perpendicular, component provides magnetic field measurements transverse, preferably perpendicular, to the axis in the direction of the offset positioning of the Hall effect sensor elements.

In other words, in one preferred embodiment, the two components of the magnetic field is one component parallel to the axis of the sensor rod and one component perpendicular to the axis in the direction of the off-axis displacement.

The estimation of the relative axial position can be performed in different ways. One straight-forward approach is to use look-up tables, where measured and digitalized magnetic strengths are used as input values. However, such a solution typically requires relatively large memory capacity to obtain a high position accuracy, which may be difficult to provide in e.g. a microcontroller system, at least if there are updating frequency demands to fulfil. However, for semi-static systems, for systems with limited position accuracy demands and for systems having access to high memory capacity in the vicinity of the linear position transducer, such solutions are indeed operable.

In a general application, it also requests that the geometrical symmetry of the ring magnet is essentially aligned with the generated magnetic field thereof. Alternatively, any rotation between the Hall effect sensor elements and the ring magnets has to be prevented and the look-up tables have to be calibrated for that particular relative rotational position.

For more demanding systems, other solutions are also available. One approach utilizes that the Hall effect sensor elements sense the magnetic field from the axial ring magnet, and the sensor output is utilized as input data to a machine-learning (ML) model. By offsetting the Hall effect sensors from the centre of the axial ring magnet and measuring the magnetic field in more than one dimension, more sensor data is available for the ML model. With multi-dimension sensing, the “gap” in data for the main signal is filled with additional data from measurements of components of other axes, as discussed above.

Machine learning (ML) is a part of artificial intelligence. In the proposed approach, the use of ML with deep neural networks (DNN), also called deep learning, a part of artificial neural network (ANN) was found to be beneficial.

In ML with DNN, a DNN is designed with an input layer, a number of hidden layers and an output layer, and a number of artificial neurons are assigned to each layer. Training algorithms are used to learn the DNN to perform specific tasks, for example pattern recognition or clustering. Training input data and related output data are used. Training of the DNN may be performed in ML-frameworks for example Tensorflow or Pytorch. These frameworks are open-source frameworks available for everyone to use. The training adds weights to the different artificial neurons by large numbers of iterative matrix calculations. This process is fully automatic and is typically not visible for the human designer. When the algorithm performs the specific task with satisfactory results the training ends, and the DNN with assigned weights is fixed. The trained DNN is a mathematical matrix with assigned weights, in ML this is called a model.

By then apply further input data to the model, the model will result in an output according to the training.

In one embodiment, the predefined relation data comprises an artificial neural network trained on data sets that represent magnetic field characteristics of at least two components of a magnetic field from at least two Hall effect sensor elements and corresponding relative positions between an axial ring magnet and the at least two Hall effect sensor elements.

One factor that may be limiting in some applications is the computing power and memory capacity of the microcontrollers that usually are utilized in position transducers. The computing complexity therefore typically has to be kept limited, in order to fit memory limitations and meet updating frequency demands. One way to limit the computing complexity is to reduce the number of magnetic field measurements that are input into the ANN at each occasion. The Hall effect sensor elements are typically provided separated by a distance close to a maximum distance still ensuring a reliable position determination. There are normally still signals representing magnetic fields substantially differing from zero from one or two Hall effect sensor elements at a time, ensuring positioning with sufficient accuracy. Therefore, the ANN used for position estimations can be adapted to operate with only four inputs of magnetic field components. This typically reduces the computing complexity and therefore also reduces the needed computing power.

In other words, in one embodiment, the artificial neural network is adapted to operate with only two components of a magnetic field from only two Hall effect sensor elements at a time as input data. These two Hall effect sensor elements are the Hall effect sensor elements with the presently strongest detected magnetic field.

By using multiple component inputs from one or more sensor element, a DNN is trained in a machine learning framework. As the DNN ML-model is a large mathematical matrix with assigned weights it may in certain applications be too big and needs too much computing power to run on microcontrollers commonly used in position transducers.

In order to run an ML-model on a microcontroller it is therefore preferably optimized to minimize the size and computing power needed. In order to do the ML-model as minimalistic as possible the position transducer is, as discussed above, preferably designed to minimize complexity of the sensor data and uses a data management design so only active sensor data is communicated at any given time.

Training, optimization and implementation of the ML-model in the overall software of the position transducer is preferably carefully verified in every step to ensure a safe functionality of the product. Training data is carefully selected after extensive analysis of expected and unexpected variances in sensor data. The training is verified to ensure necessary performance requirements such as accuracy and update frequency as well as the robustness of the ML-model. Robustness is how well the model handles non-norm sensor data as a result of environmental influences such as electromagnetic interference, temperature, vibrations etc.

After analysis, test and verification of the ML-model performance and robustness, additional software modules may preferably be added around the model. This adds safeguard actions, for example monitoring of the sensor data or other safeguard actions to monitor the ML-module and ensure safe operation of the position transducer.

The characteristics of the measured magnetic field is called magnetic signature. The signature is affected by the magnet, distance between the magnet and the Hall effect sensor elements, ferromagnetic material surrounding the magnet and external influences such as electromagnetism, temperature drift etc.

By analysis of the characteristics of the signatures, design of the magnet and linear position transducer may be optimized to minimize the variations in magnetic signature between different sensors. However, there are always some variations present due to tolerances in e.g. PCB-production, material properties, external influences etc.

The ML-model is therefore trained to handle the remaining variations and to provide correct position calculations even with some unavoidable variations in the sensor data. Correct and well-controlled training data is one key for a successful ML-model. In this case that translates to correct mapping of existing variations in the magnetic signature.

When the training of the ML-model is completed, the algorithm preferably undergoes an optimization process in order to achieve formats minimizing the size and computing power needed to run the model. It is preferred that the optimization is done without losing accuracy or other performance requirements. The optimized ML-model is implemented in overall software of the position transducer and proper safeguard actions is implemented as to ensure proper and safe operation of the position transducer.

In other words, in one embodiment, the artificial neural network is adapted to operate with formats minimizing required computation power.

To use ANN and ML to perform tasks such as positioning is, as such, not unique. However, having the ML-model as an embedded part of a linear position transducer has not been accomplished before. Prior art ML models are commonly run on devices with more computing power such as PC, smartphones or onboard computers. The challenges to re-shape the ANN format to be operable also on embedded microcontrollers are large, but tests have been performed with reasonable results in terms of accuracy and updating frequency.

The design of the ANN, the software architecture surrounding the ML-module, as well as the electronic hardware and the mechanical design are all integrated to enable the optimization needed to minimize the size and computing power needs enough to run the ML as an embedded part of a position transducer, at least for applications having high demands on accuracy and updating frequency.

The advantages of using an embedded ML-model are that more complex position calculations are possible to perform by using the locally available multi-dimension sensor data. This enables a hardware design with fewer components, which reduces the overall cost of the linear position transducer. The use of ML techniques also reduces the need for calibration procedures, such as linearization in the production process, also leading to reduction of costs and production time.

As mentioned further above, ring magnets create ideally a magnetic field that is aligned with the geometrical shape of the ring magnet. In other words, a symmetry axis of the magnetic field coincides with the geometrical symmetry line of the ring magnet. In such a case, the rotational position of the ring magnet in relation to the Hall effect sensor element becomes unimportant and rotations therebetween can be allowed without influencing the positioning accuracy. However, in practice, there may be a small deviance between the magnetic field axis and the geometrical axis of the ring magnet. Alignment errors of 5 degrees are not uncommon. A rotation relative to the Hall effect sensor element may then give rise to small fluctuations in the detected magnetic components. Such fluctuations mainly appear in the amplitude of the detected component signal, but minor shifts in offset may also be present. One solution, mentioned above, is to prevent any such relative rotation. However, this may in different application be difficult to ensure.

Surprisingly, it has now been found that the use of an ANN trained on data sets that also comprises ring magnets of various magnetic field alignment enables a reliable positioning determination despite varying magnetic field alignments of the ring magnet. In other words, the same trained ANN is capable also of determining an accurate relative position of a ring magnet having a non-perfectly aligned magnetic field, irrespective of the relative rotational position.

Embedded machine learning also opens up for continuous improvements as the ML-model can be re-trained and refined with more available sensor data.

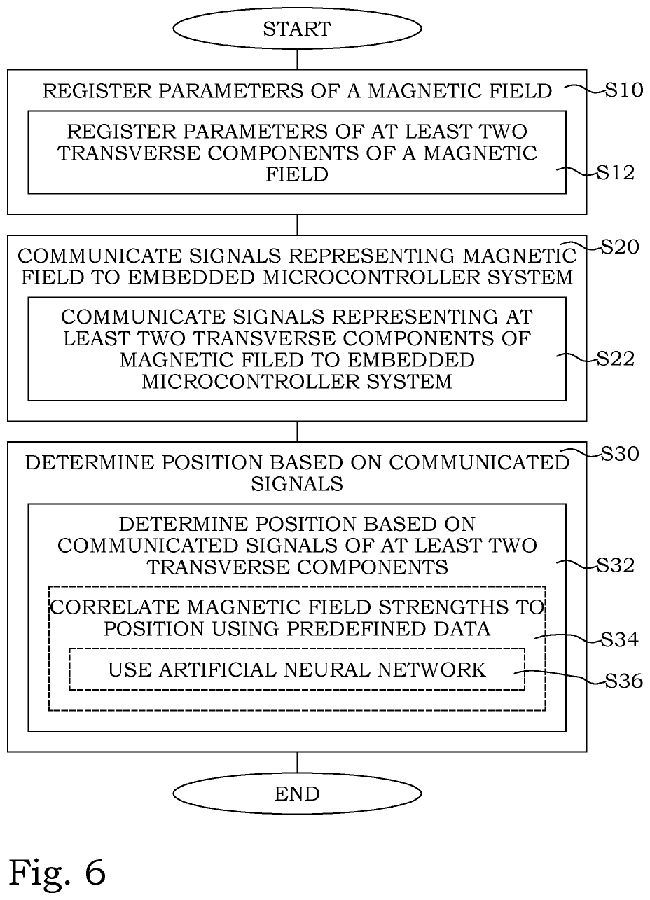

FIG. 6 is a flow diagram of steps of an embodiment of a method for determining a linear position. In step S10, parameters of a magnetic field are registered by a plurality of Hall effect sensor elements arranged within an interior of a sensor rod. The Hall effect sensor elements are arranged with an off-axis displacement with respect to an axis of the sensor rod. The sensor rod is located through an axial ring magnet. The step S10 comprises a part step S12, in which parameters of at least two transverse components of the magnetic field are registered. In step S20, signals representing the magnetic field are communicated to an embedded microcontroller system. This step comprises a part step S22, in which signals representing the parameters of at least two transverse components of the magnetic field from at least two Hall effect sensor elements are communicated. In step S30, a relative axial position between the axial ring magnet and the sensor rod is estimated based on the communicated signals representing the magnetic fields. Also this step presents a part step S32, in which the estimation is performed based on the communicated signals representing the at least two transverse components of the magnetic field from the at least two of the Hall effect sensor elements.

Preferably, step S32 comprises a further part step S34, in which the estimation of the relative axial position is performed by correlating magnetic field strengths of the at least two components of the at least two Hall effect sensor elements with a relative axial position between the axial ring magnet and the sensor rod. The correlation is performed according to predefined relation data between magnetic field strengths and relative axial positions.

Preferably, the two components of the magnetic field are a component parallel to the axis of the sensor rod and one component perpendicular to the axis in the direction of the off-axis displacement.

Preferably, step S34 also comprises a further part step S36, in which the estimation of the relative axial position is performed by entering data for the magnetic strengths into an artificial neural network. The artificial neural network is trained on data sets that represent magnetic field characteristics of at least two components of a magnetic field from at least two Hall effect sensor elements and corresponding relative positions between an axial ring magnet and the at least two Hall effect sensor elements. Thereby, the artificial neural network provides a determination of a relative position as an output.

Preferably, in one embodiment, the artificial neural network is adapted to operate with only two components of a magnetic field from only two Hall effect sensor elements at a time as input data.

Preferably, in one embodiment, the artificial neural network is adapted to operate with formats minimizing required computation power.

The use of a local microcontroller system for creating the position determination also has other challenges. To be able to estimate a linear position along a long path, many Hall effect sensor elements have to be used. When the number of Hall effect sensor elements increases, also the potential need for communication between the Hall effect sensor elements and the microcontroller system increases. In one preferred embodiment, this is solved by applying a master-slave configuration to the microcontroller system, where a number of slave microcontrollers control a respective group of Hall effect sensor elements, and where a master microcontroller communicates with the slave controllers and performs the actual position estimation.

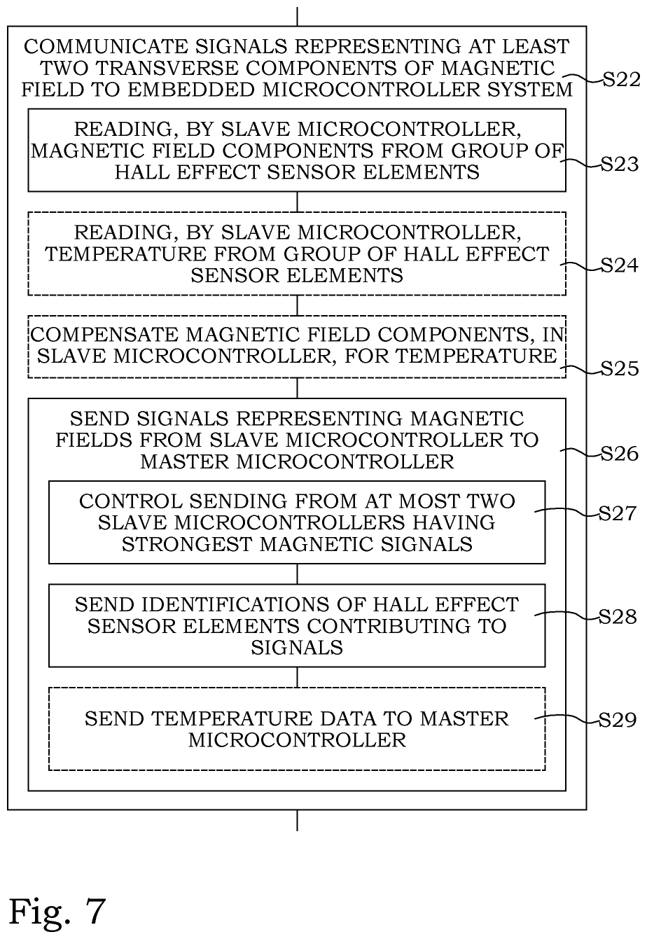

FIG. 7 illustrates a flow diagram of part steps of an embodiment of step S22 of FIG. 6. In a part step S23, data representing magnetic field components are read by slave microcontrollers from Hall effect sensor element. Each of the slave microcontroller controls a respective element array of at least two Hall effect sensor elements. In step S26, signals representing the read magnetic field components are sent from the slave microcontroller to a master microcontroller.

In a preferred embodiment, step S26 also comprises the part step S27, in which the master microcontroller controls that the step S26 of sending signals representing the read magnetic field components from the slave microcontrollers is performed by at most two of the slave microcontrollers at a time. These selected slave microcontrollers are the slave microcontrollers controlling the Hall effect sensor elements experiencing the presently strongest magnetic field.

In a further preferred embodiment, step S26 also comprises the step S28, in which identification data associated with the Hall effect sensor elements within respective element arrays that contributes to the signals representing the magnetic field as well as identification data associated with the slave microcontroller sending the signals representing the magnetic field are enclosed to the signals communicated in step S26.

In one embodiment, the element arrays comprise at most 8 Hall effect sensor elements, preferably at most 6 Hall effect sensor elements.

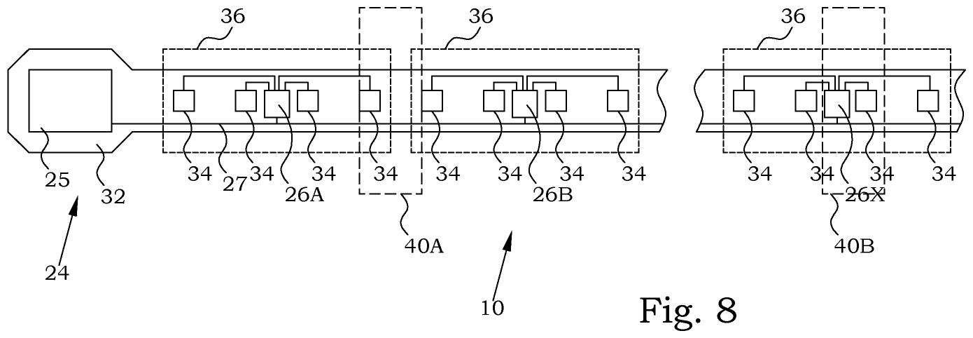

Parts of an embodiment of a linear position transducer 10 configured for such a master-slave approach is schematically illustrated in FIG. 8. The PCB 32 is, as described above provided with a number of Hall effect sensor elements 34 provided at regular distances. These Hall effect sensor elements 34 are in this embodiment grouped four and four into element arrays 36. The Hall effect sensor elements 34 within an element array 36 is controlled by a slave microcontroller 26A, 26B, 26X. In other words, each slave microcontroller 26A, 26B, 26X controls the Hall effect sensor elements 34 in one element array 36. The slave microcontrollers 26A, 26B, 26X are communicationally connected, e.g. by a communication bus 27, to a master microcontroller 25. The microcontroller system 24 comprises thus in this embodiment one master microcontroller 25 and a number of slave microcontrollers 26A, 26B, 26X.

In other words, in one embodiment, the Hall effect sensor elements are grouped into at least one element array, each one comprising at least two Hall effect sensor elements. The microcontroller system comprises a master microcontroller and slave microcontrollers. Each elements array is controlled by a respective one of the slave microcontrollers. The slave microcontrollers are communicating with the master microcontroller. Preferably, at most two of the slave microcontrollers controllers communicates measurement data to the master microcontroller at a time.

In a preferred embodiment, the slave microcontrollers are configured to, when communicating measurement data to the master microcontroller, enclose identification data associated with the Hall effect sensor elements within respective sensor groups that contributes to the measurement data as well as identification data associated with the slave microcontroller sending the measurement data.

A position 40A of the axial ring magnet is indicated by dotted lines. In this position, it is likely that the right-most Hall effect sensor element 34 in the element array 36 controlled by the slave microcontroller 26A senses the highest magnetic field. It is also likely that the left-most Hall effect sensor element 34 in the element array 36 controlled by the slave microcontroller 26B senses the second highest magnetic field. Also some of the other Hall effect sensor elements 34 in the vicinity may detect some magnetic field, but of minor magnitudes. In this situation both slave microcontrollers 26A and 26B have detected magnetic field strengths that is requested to be forwarded to the master microcontroller 25 for participating in the position estimation.

Analogously, a position 40B of the axial ring magnet is indicated by dotted lines. In this position, it is likely that the two middle Hall effect sensor elements 34 in the element array 36 controlled by the slave microcontroller 26X senses the two highest magnetic fields. In this situation, only one microcontroller 26X has detected magnetic field strengths that is requested to be forwarded to the master microcontroller 25 for participating in the position estimation.

There are, however, no situations where more than two slave microcontrollers communicate sensor data at the same time.

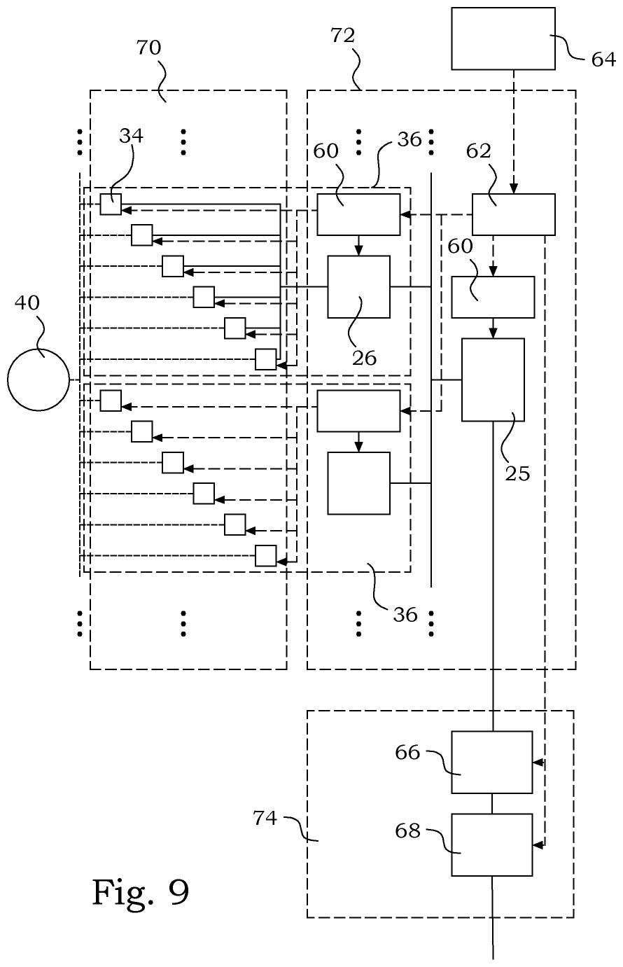

In FIG. 9, a schematic illustration of an embodiment of a transducer function diagram is shown. Some duplicate reference numbers are omitted in order to increase the readability. The axial ring magnet 40 influences at least some of the Hall effect sensor elements 34. The Hall effect sensor elements 34 are grouped into an element array 36. In this particular embodiment, the element arrays 36 comprises six Hall effect sensor elements each. The Hall effect sensor elements 34 constitute together the input section 70 of the linear position transducer. The input section 70 can easily be expanded by increasing the number of Hall effect sensor elements 34 and element arrays 36.

Each element array 36 is controlled by a respective slave microcontroller 26. The slave microcontrollers are communicationally connected to a master microcontroller 25. A DC/DC power supply 62 provides a number of low voltage power supplies 60 with power. The low voltage power supplies 60 do in turn provide power to the microcontrollers 25, 26 and to the Hall effect sensor elements 34. The DC/DC power supply 62 is in turn powered by a main supply voltage 64. The microcontrollers 25, 26 constitute together the logic section 72. The logic section 72 can easily be expanded by increasing the number of slave microcontrollers 26.

The master microcontroller 25 is connected to a digital-to-analogue converter 66 and an amplifier 68 in order to provide a final output signal representing a linear position estimate. The digital-to-analogue converter 66, or any other type of suitable converter, and the amplifier 68, together forming an output section 74, are useful regardless of the size of the input section 70 and the logic section 72.

As illustrated by FIGS. 8 and 9, in a preferred embodiment, a printed circuit board extends from the transducer head into the interior of the sensor rod. The Hall effect sensor elements and the slave microcontrollers are mounted at the printed circuit board. The communication between the slave microcontrollers and the master microcontroller takes place via the printed circuit board. The provision of one common part for building the element arrays and microcontroller system on facilitates electrical connection as well as mechanical attachments. However, alternative arrangements of the Hall effect sensor elements and the microcontrollers are also possible.

The purpose of the element array design is to manage the increased amount of sensor data used by the present technology compared to a more traditional solution. In particular, the use of ML utilizes this increased sensor data in a very efficient manner. The master microcontroller manages the element arrays via the slave microcontrollers and only calls for data from the element arrays that are needed for the ML-model to determine the position of the magnet. This saves time and computing power. In practice, useful data of detected magnetic fields is only provided by two or possibly three Hall effect sensor elements at a time. These Hall effect sensor elements are members of one or two element arrays. This means that there will be at most two slave controllers reporting data of element arrays to the master microcomputer at the same time.

The approach of having element arrays being served by slave microcontrollers also opens up for a very flexible design of the control system. Since, preferably, only at the most two microcontrollers are sending data to the master microcontroller at each time, the length of the linear position transducer can be increased and thereby also the number of required Hall effect sensor elements, without any increased demand on communication resources. Design and manufacturing of a linear position transducer with a longer stroke will thus only need additional element arrays. Required computing power and communication ability of the master microcontroller will remain the same. Thereby, the same components can be used in the shortest version as in the longest, saving time and cost in projecting and manufacturing.

The element arrays themselves should not comprise too many Hall effect sensor elements. Too many Hall effect sensor elements may unnecessarily load the slave microcontroller and in particular associated memory capacity. If spare capacity in the slave microcontrollers or memories is requested, e.g. for temperature compensation, as will be further discussed below, fewer Hall effect sensor elements in each element array may be more suitable. Also, a decrease in the number of Hall effect sensor elements in each element arrays will also improve the overall modularity. If relatively few Hall effect sensor elements are provided in each element array, a certain requested stroke length of the linear position transducer can easily be met by simply selecting an appropriate number of entire element arrays. Different stroke lengths can thereby be met by selecting an appropriate number of element arrays, but still using the same software for the operation. For many microcontrollers and memory entities today, when arranged for operating as a slave microcontroller, eight Hall effect sensor elements in each element array is typically manageable. However, for the modularity reasons, the number is preferably further reduced, e.g. to six Hall effect sensor elements in each element array. A further reduction of the number of Hall effect sensor elements to e.g. four will further improve the modularity.

In other words, in one embodiment, each element arrays comprises at most 8 Hall effect sensor elements, preferably at most 6 Hall effect sensor elements, and most preferably at most 4 Hall effect sensor elements (34).

In Hall effect sensor elements available today, there are typically some additional features, beyond the pure magnetic field sensing, incorporated. Such additional features could e.g. be different kinds of noise reduction, filters or other signal treatments. Such signal processing could also be incorporated in the slave microcontrollers as an alternative, or in combination.

One particular issue concerning signal modification is temperature compensation. The Hall effect sensor elements are typically temperature dependent and the output will therefore be different if the temperature changes are considerable. The Hall effect sensor elements may, as indicated above, be configured to automatically compensate for measured temperatures at the Hall effect sensor elements. Alternatively, the Hall effect sensor elements may measure the temperature and provide such information to the associated slave microcontroller. This is illustrated in FIG. 7 as step S24.

The slave microcontroller can in one embodiment use this temperature read from the Hall effect sensor elements to compensate the likewise read magnetic field components for temperature changes. This is illustrated as step S25.

In another embodiment, the slave microcontrollers may only act as a forwarding unit, concerning the temperature information. To this end, in step S29, temperature data is sent from the slave microcontroller to the master microcontroller. The temperature data concerns the magnetic fields, which the signals of step S26 represent. The master microcontroller can then utilize this temperature information to compensate the magnetic field information.

In other words, the Hall effect sensor elements are configured to provide signals representing a temperature at respective the Hall effect sensor element. The slave microcontrollers are configured for forwarding information concerning the respective temperature to the master microcontroller. Finally, the master microcontroller is configured for compensating the signals representing a magnetic field from the Hall effect sensor elements for the respective temperature.

Analogously, in a method point of view, the step of reading data representing magnetic field components from Hall effect sensors further comprises reading of signals representing a temperature at respective the Hall effect sensor element. The step of sending signals representing the read magnetic field components from the slave microcontroller to a master microcontroller further comprises forwarding information concerning the respective temperature to the master microcontroller. The method for determining a linear position then also comprises the further step of, in the master microcontrollers, compensating the signals representing a magnetic field for respective temperature.

When the linear position estimation makes use of ML, temperature data as such may operate well also as an input variable to the ANN. The temperature variations of the measured magnetic fields are relatively simple and are not expected to significantly increase the complexity of the trained ANN very much. At the same time, variations in the magnetic field measuring and variations in the temperature measurements may be correlated and such correlations are then advantageously automatically taken care of by the ANN. The communication of the temperature readings does not considerably increase the load. As a summary, very moderate load-demanding steps of forwarding temperature measures from the Hall effect sensor elements via the slave microcontrollers to the master microcontroller and very moderate increased complexity of the ANN opens up for an efficient and reliable temperature-considering estimation of a position.

In other words, in one embodiment, the artificial neural network is trained on training data further comprising Hall effect sensor element temperature measures. The artificial neural network is thereby configured to perform the compensation of the signals representing a magnetic field from the Hall effect sensor elements for the respective temperature.

Analogously, in a method point of view, the artificial neural network is trained on training data further comprising Hall effect sensor element temperature measures. The compensation of the signals representing a magnetic field from the Hall effect sensor elements for the respective temperature is performed by the artificial neural network.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1-27. (canceled)

28. A linear position transducer, comprising:
a sensor rod;
a plurality of Hall effect sensor elements arranged along an axis of said sensor rod within an interior of said sensor rod;
said Hall effect sensor elements being configured to provide signals representing a magnetic field at the position of respective said Hall effect sensor element;
said Hall effect sensor elements being configured to provide signals representing at least two components, transverse to each other, of a magnetic field at the position of respective said Hall effect sensor element;
an axial ring magnet having a hole with a diameter larger than a diameter of said sensor rod;
said axial ring magnet being arranged around said sensor rod; and
an embedded microcontroller system communicationally connected to said plurality of Hall effect sensor elements for receiving signals representing magnetic fields;
said microcontroller system being configured for determining a relative axial position between said axial ring magnet and said sensor rod based on said received signals representing magnetic fields;
said Hall effect sensor elements are arranged with an off-axis displacement with respect to an axis of said sensor rod; and
said microcontroller system being configured for determining said relative axial position based on received signals representing said at least two components of said magnetic field from each of at least two of said Hall effect sensor elements.

29. The linear position transducer according to claim 28, wherein said microcontroller system is configured for determining said relative axial position by correlating magnetic field strengths of said at least two components of said at least two Hall effect sensor elements with a relative axial position between said axial ring magnet and said sensor rod, said correlation being performed according to predefined relation data between magnetic field strengths and relative axial positions.

30. The linear position transducer according to claim 30, wherein said predefined relation data comprises an artificial neural network trained on data sets that represent magnetic field characteristics of two components of a magnetic field from at least two Hall effect sensor elements and corresponding relative positions between an axial ring magnet and said at least two Hall effect sensor elements.

31. The linear position transducer according to claim 30, wherein said artificial neural network is adapted to operate with only two components of a magnetic field from only two Hall effect sensor elements at a time as input data, said two Hall effect sensor elements being the Hall effect sensor elements with the presently strongest detected magnetic field.

32. The linear position transducer according to claim 28, wherein said Hall effect sensor elements are grouped into at least one element array of at least two Hall effect sensor elements, said microcontroller system comprising a master microcontroller and slave microcontrollers, each element array being controlled by a respective said slave microcontroller, wherein said slave microcontrollers are communicating with said master microcontroller.

33. The linear position transducer according to claim 32, wherein at most two of said slave microcontrollers controllers communicates measurement data to said master microcontroller at a time.

34. The linear position transducer according to claim 33, wherein said slave microcontrollers, when communicating measurement data to said master microcontroller, encloses identification data associated with the Hall effect sensor elements within respective element arrays that contributes to said measurement data as well as identification data associated with the slave microcontroller sending said measurement data.

35. The linear position transducer according to claim 32, wherein said Hall effect sensor elements are configured to provide signals representing a temperature at respective said Hall effect sensor element, and wherein said slave microcontrollers are configured for forwarding information concerning said respective temperature to said master microcontroller, and wherein said master microcontroller is configured for compensating said signals representing a magnetic field from said Hall effect sensor elements for said respective temperature.

36. The linear position transducer according to claim 32, further comprising a printed circuit board extending from a transducer head into said interior of said sensor rod, wherein said Hall effect sensor elements and said slave microcontrollers are mounted at said printed circuit board, and wherein said communication between said slave microcontrollers and said master microcontroller takes place via said printed circuit board.

37. The linear position transducer according to claim 28, wherein said Hall effect sensor elements are spaced apart along said axis of said sensor rod by more than 20 mm, preferably by more than 25 mm.

38. A cylinder of piston type, comprising a piston and a cylinder body, and a linear position transducer according to claim 28.

39. A method for determining a linear position, comprising the steps of:
registering parameters of a magnetic field by a plurality of Hall effect sensor elements arranged along an axis of a sensor rod within an interior of the sensor rod, said sensor rod being located through an axial ring magnet;
wherein said step of registering parameters of a magnetic field comprises registering parameters of at least two transverse components of said magnetic field;
communicating signals representing said magnetic field to an embedded microcontroller system; and
determining a relative axial position between said axial ring magnet and said sensor rod based on said communicated signals representing said magnetic fields;
said Hall effect sensor elements are arranged with an off-axis displacement with respect to an axis of said sensor rod;
wherein said step of communicating signals comprises communicating signals representing said parameters of at least two transverse components of said magnetic field from at least two Hall effect sensor elements; and
wherein said step of determining said relative axial position is performed based on communicated signals representing said at least two transverse components of said magnetic field from each of said at least two of said Hall effect sensor elements.

40. The method according to claim 39, wherein said step of determining said relative axial position is performed by correlating magnetic field strengths of said at least two components of said at least two Hall effect sensor elements with a relative axial position between said axial ring magnet and said sensor rod, said correlating being performed according to predefined relation data between magnetic field strengths and relative axial positions.

41. The method according to claim 40, wherein said step of determining said relative axial position is performed by entering data for said magnetic strengths into an artificial neural network, said artificial neural network being trained on data sets that represent magnetic field characteristics of at least two components of a magnetic field from at least two Hall effect sensor elements and corresponding relative positions between an axial ring magnet and said at least two Hall effect sensor elements, whereby said artificial neural network provides an estimate of a relative position as an output.

42. The method according to claim 41, wherein said artificial neural network is adapted to operate with only two components of a magnetic field from only two Hall effect sensor elements at a time as input data.

43. The method according to claim 39, wherein said step of communicating signals representing said magnetic field comprises the part steps of:
reading, by slave microcontrollers, data representing magnetic field components from Hall effect sensor elements, wherein each of said slave microcontroller controls an element array of at least two Hall effect sensor elements; and
sending signals representing said read magnetic field components from said slave microcontroller to a master microcontroller.

44. The method according to claim 43, wherein said step of communicating signals representing said magnetic field comprises the further step of:
controlling, by said master microcontroller, that said step of sending signals representing said read magnetic field components from said slave microcontrollers is performed by at most two of said slave microcontrollers at a time, said at most two of said slave microcontrollers being the slave microcontrollers controlling the Hall effect sensor elements experiencing the presently strongest magnetic field.

45. The method according to claim 44, wherein said step of communicating signals representing said magnetic field comprises the further step of:
sending identification data associated with the Hall effect sensor elements within respective sensor groups that contributes to said signals representing said magnetic field as well as identification data associated with the slave microcontroller sending said signals representing said magnetic field.

46. The method according to claim 43, wherein said step of reading data representing magnetic field components from Hall effect sensor elements further comprises reading of signals representing a temperature at respective said Hall effect sensor element, and that said step of sending signals representing said read magnetic field components from said slave microcontroller to a master microcontroller comprises forwarding information concerning said respective temperature to said master microcontroller, and wherein said method comprises the further step of, in said master microcontrollers, compensating said signals representing a magnetic field for respective temperature.

47. The method according to claim 46, wherein said step of determining said relative axial position is performed by entering data for said magnetic strengths into an artificial neural network, said artificial neural network being trained on data sets that represent magnetic field characteristics of at least two components of a magnetic field from at least two Hall effect sensor elements and corresponding relative positions between an axial ring magnet and said at least two Hall effect sensor elements, whereby said artificial neural network provides an estimate of a relative position as an output, and wherein said artificial neural network is trained on training data further comprising Hall effect sensor element temperature measures, whereby said compensation of said signals representing a magnetic field from said Hall effect sensor elements for said respective temperature is performed by said artificial neural network.
